(19) United States
(12) Patent Application Publication
(10) Pub. No.: US 2007/0023552 A1
(43) Pub. Date: Feb. 1, 2007

(54) Shredders

(75) Inventors: Michael John Easton, Hampshire (GB); Michael David Sawford, Buckinghamshire (GB)

Correspondence Address: MICHAEL BEST & FRIEDRICH, LLP, 100 E WISCONSIN AVENUE, MILWAUKEE, WI, 53202, US

(73) Assignee: Acco UK Limited, Buckinghamshire (GB)

(21) Appl. No.: 11/404,056

(22) Filed: Apr. 13, 2006

(30) Foreign Application Priority Data
Apr. 22, 2005 (GB) 0508149.2

(51) Int. Cl. B02C 18/22

(52) U.S. Cl. 241/100; 241/236

(57) ABSTRACT

A compression device, adapted for use with a shredder having an output aperture from which shredded material is output, comprising first and second compression plates, each compression plate adapted for attachment at the output aperture of the shredder, and each being pivotably moveable between respective first positions in which the compression plates act to impede the flow of the shredded material away from the output aperture of the shredder, to respective second positions in which the shredded material is allowed to flow away from the output aperture of the shredder, between the compression plates, wherein the free ends of the compression plates, remote from their attachment at the output aperture of the shredder, are biased towards each other by respective resilient members.

### FIELD OF INVENTION

The invention relates to the compression of shredded material output from a shredder.

Conventional shredding devices, particularly so-called straight cut shredders, output strips of shredded material, e.g. paper. The strips of shredded material are substantially uncompressed, and can quickly fill a receptacle used to collect them. It is desirable to compress the shredded material in some way, to extend the usage of the receptacle.

### SUMMARY OF THE INVENTION

According to a first aspect of the invention there is provided a compression device, adapted for use with a shredder having an output aperture from which shredded material is output, comprising first and second compression plates, each compression plate adapted for attachment at the output aperture of the shredder, and each being pivotably moveable between respective first positions in which the compression plates act to impede the flow of the shredded material away from the output aperture of the shredder, to respective second positions in which the shredded material is allowed to flow away from the output aperture of the shredder, between the compression plates, wherein the free ends of the compression plates, remote from their attachment at the output aperture of the shredder, are biased towards each other by respective resilient members.

Compression of the shredded material takes place prior to collection thereof in a receptacle, and more shredded material may therefore be collected before the receptacle requires to be emptied. The shredded material is therefore compressed between the compression plates and a shredding head of the shredder. Where the shredded material comprises, for example, a plurality of strips of material, e.g. paper, the compression device in accordance with the invention therefore causes at least some of the strips of material to concertina.

Each compression plate may be hingeably attachable to the shredder at the output aperture thereof. Each compression plate may be hingeably attachable to the shredder by means of hinges, or fasteners or gluing.

Each resilient member may be an elastic band which, preferably, extends over a portion of the compression plate and is connectable at each of its ends to the shredder. Alternatively each resilient member may be provided as an integral part of the hinge of each compressor plate, where the plates are hingeably attachable to the shredder, for example as part of a living hinge.

The compression plates may be elongate in shape, to impede the flow of shredded material away from an elongate output aperture of the shredder. Each elongate compression plate may have a first elongate edge and a second elongate edge joined to the first elongate edge by first and second end edges of the compression plate. The first and second elongate edges may each have a length which is substantially equal to or greater than the length of elongate edges of the output aperture of the shredder.

The first elongate edge of the first compression plate may be attachable to the shredder alongside a first elongate edge of the output aperture, and the first elongate edge of the second compression plate may be attachable to the shredder alongside a second elongate edge of the output aperture.

When the compression plates are attached to the shredder, they are biased towards each other by the respective resilient members to form a substantially V-shaped compartment adjacent the output aperture of the shredder.

The compression device may be provided with one or more pressure sensing and actuating elements, to measure the pressure on the compression plates, and to cause the compression plates to move abruptly from the first position to the second position when the pressure on the plates equals or substantially equals a predetermined level. The compression device may be provided with one or more pressure sensing and actuating elements, to measure the pressure on the compression plates, and to cause the compression plates to move abruptly from the second position to the first position when the pressure on the plates drops below a predetermined level. The actuating elements may thus be configured to effect pivotal movement of the compression plates. Actuating elements for providing such movement are well, for example a electric motor with appropriate gearing could be used.

According to a second aspect of the invention there is provided a shredding device including a shredder and a compression device according to the first aspect of the invention.

### DESCRIPTION OF THE DRAWINGS

An embodiment of the invention will now be described, by way of example only, with reference to the accompanying drawings, in which:

FIG. 1 is a perspective view of a shredder and a compression device according to the first aspect of the invention;

FIG. 2 is a cross sectional view of the shredder and the compression device of FIG. 1, shown with compression plates of the compression device in a first position, and

FIG. 3 is a cross sectional view of the shredder and the compression device of FIG. 1, shown with compression plates of the compression device in a second position.

### DESCRIPTION OF THE PREFERRED EMBODIMENTS OF THE INVENTION

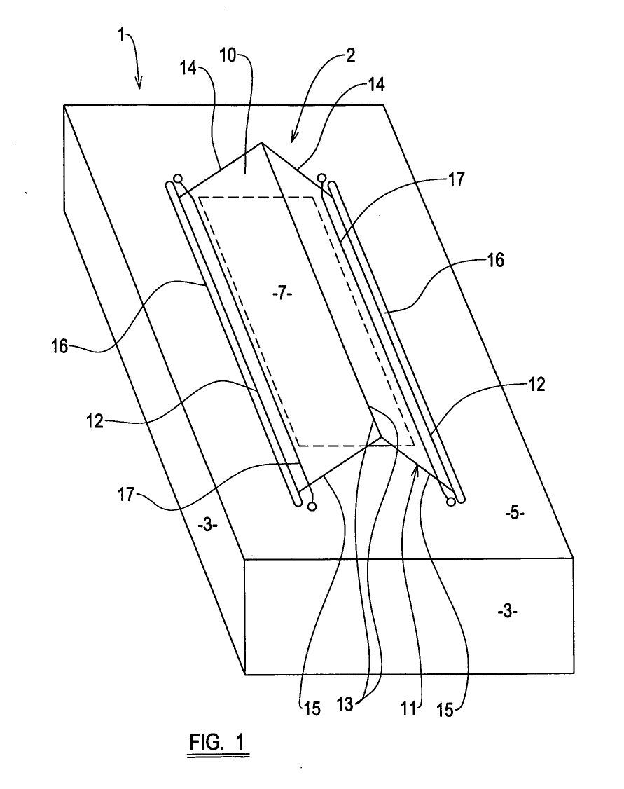

FIGS. 1, 2 and 3 show a shredder 1 and a compression device 2. The shredder comprises a casing which is generally box-shaped, and comprises four sides 3 (only two of which are visible in each of the Figures), which join a first face 4, and a second face 5. The first face 4 is provided with an elongate input aperture 6, through which material, such as paper, which is to be shredded is fed into the shredder. The second face 5 is provided with an elongate output aperture 7, from which shredded material is output from the shredder. The shredder casing contains a shredding head 8, which receives material from the input aperture 6, shreds it, and outputs the shredded material to the output aperture 7. The shredding head 8 may shred the material into elongate strips. The shredder may be designed to fit onto a receptacle for the shredded material, i.e. may comprise a so-called ‘bin-top’ shredder. Alternatively, the shredder may be positioned over a receptacle for the shredded material. Such shredders are often referred to as ‘cabinet’ shredders. In either case, in use, the first face 4 of the shredder comprises an upper, generally horizontal surface of the shredder, and the second face 5 comprises a lower, generally horizontal surface of the shredder. Material may be easily fed into the shredder through the elongate input aperture 6 in the upper face 4, and shredded material may easily fall away from the elongate output aperture 7 in the lower face 5 under the influence of gravity, into the receptacle beneath the shredder.

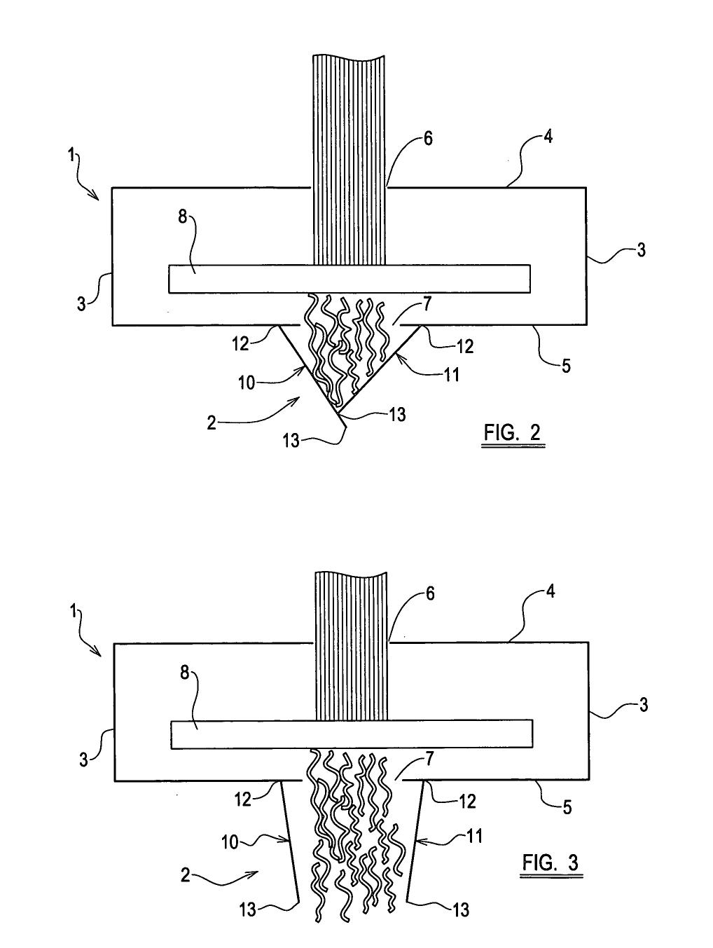

The compression device 2 comprises a first compression plate 10 and a second compression plate 11. Each compression plate is elongate in shape, and comprises a first elongate edge 12 and a second elongate edge 13 joined to the first elongate edge 12 by first and second end edges 14, 15. The first and second elongate edges 12, 13 each have a length which is substantially equal to or greater than the length of elongate edges of the elongate output aperture 7 of the shredder. For each compression plate 10, 11, the first elongate edge 12 is attached to the face 5 of the shredder alongside opposite elongate edges of the output aperture 7, as shown. The attachment may be by any suitable fastening means, such as a strip of adhesive fastener 16, which, for each compression plate, is adhered to the edge 12 of each plate and the face 5 of the shredder, to attach the plate to the shredder. Each compression plate 10, 11 is hingeably attached to the shredder by the adhesive fastener, such that the plate is movable from a first position (shown in FIG. 2) in which it acts to impede the flow of shredded material away from the output aperture 7 of the shredder, to a second position (shown in FIG. 3) in which the shredded material is allowed to flow away from the output aperture 7 of the shredder, and from the second position to the first position. When in the first position, the compression plates 10, 11 overlap at their second elongate edges 13, and form a substantially V-shaped compartment adjacent the output aperture 7 of the shredder. Each compression plate 10, 11 is tensioned by a resilient member 17, comprising an elastic band, which is fixed to the shredder over a portion of the compression plate, as shown. Each resilient member acts to bias the plate over which it is fixed into the first position, and controls movement of the plate from the first position to the second position and vice versa.

The compression plates of the compression device are attached to the shredder, as described above, and the shredder/compression device combination placed over a receptacle for use. The compression plates 10, 11 are each biased by the resilient members 17 into their first position, shown in FIG. 2. Material to be shredded is fed through the input aperture 6 of the shredder and is shredded by the shredding head 8 into strips of shredded material. The strips of shredded material are output from the shredding head in a relatively uncompressed form, and are output from the shredder through the output aperture 7. Flow of the strips away from the output aperture 7 is impeded by the compression plates 10, 11 in their first position (FIG. 1), and this causes the strips to be compressed between the plates and the shredding head of the shredder, into a concertina shape. As more strips of shredded material are output from the output aperture 7, the pressure exerted by the strips on each compression plate increases. This gradually overcomes the tension of each plate, to produce gradual movement thereof from the first position to, or at least towards, the second position, shown in FIG. 3. As each compression plate moves from its first position towards its second position, compression of the strips of shredded material will continue. As the pressure exerted on each compression plate by the strips of shredded material decreases (e.g. due to a fall-off in the volume of material being input into the shredder) each plate will move towards its first position. When the compression plates reach their second position, the compressed strips of shredded material are allowed to flow away from the output aperture 7 into a receptacle (not shown) for their collection. Compression of the strips of shredded material prior to collection thereof in the receptacle, allows more shredded material to be collected before the receptacle requires emptying.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A compression device, adapted for use with a shredder having an output aperture from which shredded material is output, comprising first and second compression plates, each compression plate adapted for attachment at the output aperture of the shredder, and each being pivotably moveable between respective first positions in which the compression plates act to impede the flow of the shredded material away from the output aperture of the shredder, to respective second positions in which the shredded material is allowed to flow away from the output aperture of the shredder, between the compression plates, wherein the free ends of the compression plates, remote from their attachment at the output aperture of the shredder, are biased towards each other by respective resilient members.

2. A compression device according to claim 1, wherein each compression plate is hingeably attachable to the shredder at the output aperture thereof.

3. A compression device according to claim 1 wherein each resilient member is an elastic band, which extends over a portion of its respective compression plate, and is connectable at each of its ends to the shredder.

4. A compression device according to claim 2 wherein each resilient member is provided as an integral part of the hinge of its respective compression plate.

5 A compression device according to claim 1 in which each compression plate is elongate in shape.

6. A compression device according to claim 1 including one or more pressure sensing and actuating elements, to measure the pressure on the compression plates, and to cause the compression plates to move abruptly from the first position to the second position when the pressure on the plates equals or substantially equals a predetermined level.

7. A compression device according to any one of claim 1 including one or more pressure sensing and actuating elements, to measure the pressure on the compression plates, and to cause the compression plates to move abruptly from the second position to the first position when the pressure on the plates drops below a predetermined level.

8. In combination, a shredder and a compression device, the shredder having an output aperture from which shredded material is output, and the compressing device comprising first and second compression plates, each compression plate adapted for attachment at the output aperture of the shredder, and each being pivotably moveable between respective first positions in which the compression plates act to impede the flow of the shredded material away from the output aperture of the shredder, to respective second positions in which the shredded material is allowed to flow away from the output aperture of the shredder, between the compression plates, wherein the free ends of the compression plates, remote from their attachment at the output aperture of the shredder, are biased towards each other by respective resilient members.
